(19) United States
(12) Patent Application Publication
(10) Pub. No.: US 2026/0302336 A1
(43) Pub. Date: Oct. 1, 2026

(54) ALL-SOLID-STATE RECHARGEABLE BATTERIES

(71) Applicant: SAMSUNG SDI CO., LTD., Yongin-si, Gyeonggi-do (KR)

(72) Inventors: Jaejun LEE, Yongin-si, Gyeonggi-do (KR); Eungyeong LEE, Yongin-si, Gyeonggi-do (KR); Jaemin KIM, Yongin-si, Gyeonggi-do (KR); Gunwook LEE, Yongin-si, Gyeonggi-do (KR); Sieun LEE, Yongin-si, Gyeonggi-do (KR)

(73) Assignee: SAMSUNG SDI CO., LTD., Yongin-si, Gyeonggi-do (KR)

(21) Appl. No.: 18/880,229

(22) PCT Filed: Apr. 3, 2024
(86) PCT No.: PCT/KR2024/004363

§ 371 Date: Dec. 30, 2024

(30) Foreign Application Priority Data
Sep. 21, 2023 (KR) 10-2023-0126493

(51) Int. Cl. H01M 10/0562; H01M 4/62; H01M 10/0525; H01M 10/0585; H01M 50/434; H01M 50/449

(52) U.S. Cl. CPC H01M 10/0562; H01M 4/625; H01M 4/626; H01M 10/0525; H01M 10/0585; H01M 50/434; H01M 50/449; H01M 2300/0068; H01M 2300/0094

(57) ABSTRACT

An all-solid-state rechargeable battery includes a negative electrode, a positive electrode, and a solid electrolyte layer between the negative electrode and the positive electrode, wherein the solid electrolyte layer includes a region including solid electrolyte particles and an electronic conductive material on a side in contact with the negative electrode.

### TECHNICAL FIELD

All-solid-state rechargeable batteries are disclosed.

### BACKGROUND ART

A portable information device such as a cell phone, a laptop, smart phone, and the like or an electric vehicle has used a rechargeable lithium battery having high energy density and easy portability as a driving power source. Recently, research has been actively conducted to use a rechargeable lithium battery with high energy density as a driving power source or power storage power source for hybrid or electric vehicles.

Because commercially available rechargeable lithium batteries use electrolyte solutions including flammable organic solvents, there are safety issues such as explosion or fire of the batteries in the event of collision, penetration, and the like. Accordingly, an all-solid-state rechargeable battery using a solid electrolyte instead of an electrolyte solution has been proposed. All-solid-state rechargeable batteries are batteries in which all materials are made of solid, and thus they are safe as there is no risk of electrolyte solution leaking and exploding, and have the advantage of being easy to manufacture thin batteries, and can reduce the thickness of the negative electrode, improving high-rate charging and discharging performance, and realizing high-voltage driving and high energy density.

### DISCLOSURE

By maximizing a contact area between the negative electrode and the solid electrolyte layer to maximize a movement path of lithium ions, improving contact uniformity to improve the movement uniformity of lithium ions, reducing interfacial resistance, and maintaining contact between the negative electrode and the solid electrolyte layer even when the volume of the electrode changes during charge and discharge, the performance of the all-solid-state rechargeable battery is improved.

In an embodiment, an all-solid-state rechargeable battery includes a negative electrode, a positive electrode, and a solid electrolyte layer between the negative electrode and the positive electrode, wherein the solid electrolyte layer includes a region including solid electrolyte particles and an electronic conductive material on a side in contact with the negative electrode.

In an all-solid-state rechargeable battery according to an embodiment, the contact area between the negative electrode and the solid electrolyte layer is maximized and the contact uniformity is high, so that the interfacial resistance is reduced, and the contact between the negative electrode and the solid electrolyte layer is maintained even when the electrode volume changes during charge and discharge, and the formation of lithium dendrites is suppressed, so that the electrochemical characteristics such as the initial charge and discharge efficiency are improved.

### DESCRIPTION OF THE DRAWINGS

FIGS. 1 and 2 are cross-sectional views schematically showing all-solid-state rechargeable batteries according to embodiments.

### BEST MODE

Hereinafter, specific embodiments will be described in detail so that those of ordinary skill in the art can easily implement them. However, this disclosure may be embodied in many different forms and is not construed as limited to the example embodiments set forth herein.

The terminology used herein is used to describe embodiments only, and is not intended to limit the present invention. The singular expression includes the plural expression unless the context clearly dictates otherwise.

As used herein, “combination thereof” means a mixture, a laminate, a composite, a copolymer, an alloy, a blend, a reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

The average particle diameter may be measured by a method well known to those skilled in the art, for example, may be measured by a particle size analyzer, or may be measured by a transmission electron microscopic photograph or a scanning electron microscopic photograph. Alternatively, it is possible to obtain an average particle diameter value by measuring using a dynamic light scattering method, performing data analysis, counting the number of particles for each particle size range, and calculating from this. Unless otherwise defined, the average particle diameter may mean the diameter (D50) of particles having a cumulative volume of 50 volume % in the particle size distribution. As used herein, when a definition is not otherwise provided, the average particle diameter means a diameter (D50) of particles having a cumulative volume of 50 volume % in the particle size distribution that is obtained by measuring the size (diameter or length of the major axis) of about 20 particles at random in a scanning electron microscope image.

Herein, “or” is not to be construed as an exclusive meaning, for example, “A or B” is construed to include A, B, A+B, and the like.

“Metal” is interpreted as a concept including ordinary metals, transition metals and metalloids (semi-metals).

### All-Solid-State Rechargeable Battery

In an embodiment, an all-solid-state rechargeable battery includes a negative electrode, a positive electrode, and a solid electrolyte layer between the negative electrode and the positive electrode, wherein the solid electrolyte layer includes a region including solid electrolyte particles and an electronic conductive material on a side in contact with the negative electrode.

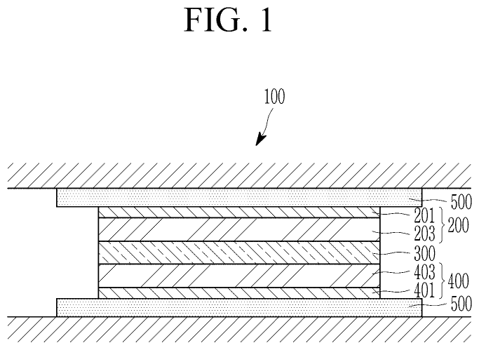

FIG. 1 is a cross-sectional view of an all-solid-state rechargeable battery according to an embodiment. Referring to FIG. 1, the all-solid-state rechargeable battery 100′ may have a structure that an electrode assembly, in which a negative electrode 400 including a negative electrode current collector 401 and a negative electrode active material layer 403, a solid electrolyte layer 300, and a positive electrode 200 including a positive electrode active material layer 203 and a positive electrode current collector 201 are stacked, is housed in a battery case. The all-solid-state rechargeable battery 100′ may further include at least one elastic layer 500 on the outside of at least either one of the positive electrode 200 and the negative electrode 400. Although FIG. 1 shows one electrode assembly including the negative electrode 400, the solid electrolyte layer 300, and the positive electrode 200, an all-solid-state rechargeable battery can also be manufactured by stacking two or more electrode assemblies.

### Solid Electrolyte Layer

The solid electrolyte layer includes solid electrolyte particles. A solid electrolyte layer according to an embodiment includes a region including solid electrolyte particles and an electronic conductive material on a side in contact with the negative electrode. The region may be a portion of the solid electrolyte layer that comes into contact with the negative electrode. Due to the region, the bonding area between the negative electrode and the solid electrolyte layer can be maximized and the void at the interface can be minimized.

### Solid Electrolyte Particles

The solid electrolyte particles may be, for example, sulfide-based solid electrolyte particles having excellent ionic conductivity. The sulfide-based solid electrolyte particles may include, for example, Li₂S—P₂S₅, Li₂S—P₂S₅—LiX (wherein X is a halogen element, for example I, or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n is each an integer and Z is Ge, Zn, or Ga), Li₂S—GeS₂, Li₂S—SiS₂—Li₃PO₄, Li₂S—SiS₂-LiₚMO_{q} (wherein p and q each an integer and M is P, Si, Ge, B, Al, Ga, or In), or a combination thereof.

Such a sulfide-based solid electrolyte may be obtained by, for example, mixing Li₂S and P₂S₅ in a molar ratio of 50:50 to 90:10 or 50:50 to 80:20 and optionally, performing heat treatment. Within the above mixing ratio range, a sulfide-based solid electrolyte having excellent ionic conductivity can be manufactured. Here, other components such as SiS₂, GeS₂, and B₂S₃ may be added to further improve the ionic conductivity.

Mechanical milling or a solution method may be applied as a mixing method of sulfur-containing raw materials for preparing a sulfide-based solid electrolyte. The mechanical milling is to make starting materials into particulates by putting the starting materials in a ball mill reactor and fervently stirring them. The solution method may be performed by mixing the starting materials in a solvent to obtain a solid electrolyte as a precipitate. In addition, in the case of heat treatment after mixing, crystals of the solid electrolyte may be more robust and ionic conductivity may be improved. For example, the sulfide-based solid electrolyte may be prepared by mixing sulfur-containing raw materials and performing heat treatment two or more times. In this case, a sulfide-based solid electrolyte having high ionic conductivity and robustness may be prepared.

The sulfide-based solid electrolyte according to an embodiment, for example, may be prepared through a first heat treatment of mixing sulfur-containing raw materials and firing at 120° C. to 350° C. and a second heat treatment of mixing the resultant of the first heat treatment and firing the same at 350° C. to 800° C. The first heat treatment and the second heat treatment may be performed in an inert gas or nitrogen atmosphere, respectively. The first heat treatment may be performed for 1 hour to 10 hours, and the second heat treatment may be performed for 5 hours to 20 hours. Small raw materials may be milled through the first heat treatment, and a final solid electrolyte can be synthesized through the second heat treatment. Through such two or more heat treatments, a robust sulfide-based solid electrolyte having high ionic conductivity and high performance can be obtained, and such a solid electrolyte may be suitable for mass production. The temperature of the first heat treatment may be, for example, 150° C. to 330° C., or 200° C. to 300° C., and the temperature of the second heat treatment may be, for example, 380° C. to 700° C., or 400° C. to 600° C.

For example, the sulfide-based solid electrolyte may include argyrodite-type sulfide. The argyrodite-type sulfide may be represented by, for example, a chemical formula of LiₐM_{b}P_{c}S_{d}Aₑ (wherein a, b, c, d, and e are all 0 or more and 12 or less, M is Ge, Sn, Si, or a combination thereof, and A is F, Cl, Br, or I), and as a specific example, may be represented by a chemical formula of Li₇₋ₓPS₆₋ₓAₓ (wherein x is 0.2 or more and 1.8 or less, and A is F, Cl, Br, or I). The argyrodite-type sulfide may specifically be Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, etc.

The sulfide-based solid electrolyte including such an argyrodite-type sulfide-based solid electrolyte may have high ionic conductivity close to the range of 10⁻⁴ to 10⁻² S/cm, which is the ionic conductivity of general liquid electrolytes at room temperature, and may form an intimate bond between the positive electrode active material and the solid electrolyte without causing a decrease in ionic conductivity, and furthermore, an intimate interface between the electrode layer and the solid electrolyte layer. An all-solid-state rechargeable battery including this can have improved battery performances such as rate capability, coulombic efficiency, and cycle life characteristics.

The argyrodite-type sulfide-based solid electrolyte may be prepared, for example by mixing lithium sulfide and phosphorus sulfide, and optionally lithium halide. Heat treatment may be performed after mixing them. The heat treatment may include, for example, two or more heat treatment steps. Here, the preparing of the argyrodite-type sulfide-based solid electrolyte may include, for example, a first heat treatment in which raw materials are mixed and fired at 120° C. to 350° C., and a second heat treatment in which the resultant of the first heat treatment is mixed again and fired at 350° C. to 800° C.

The average particle size (D50) of the solid electrolyte particles may be less than or equal to 5.0 μm, for example, 0.1 μm to 5.0 μm, 0.5 μm to 5.0 μm, 0.5 μm to 4.0 μm, 0.5 μm to 3.0 μm, 0.5 μm to 2.0 μm, or 0.5 μm to 1.0 μm. The solid electrolyte particles may be small particles having a size of 0.1 μm to 1.5 μm, large particles having a size of 2.0 μm to 5.0 μm, or a mixture thereof. The average particle diameter of the solid electrolyte particles may be measured using an electron microscope image, and for example, a particle size distribution may be obtained by measuring the size (diameter or length of the major axis) of about 20 particles in a scanning electron microscope image, and D50 may be calculated therefrom.

### Electron Conductive Material

The electronic conductive material may be applied without limitation to any type as long as it is electronically conductive and does not adversely affect the battery, and may include, for example, a carbon-based material, a metal-based material, a conductive polymer, or a combination thereof.

The carbon-based material may include, for example, natural graphite, artificial graphite, carbon black, acetylene black, denka black, ketjen black, carbon fiber, carbon nanofiber, carbon nanotube, or a combination thereof. The metal-based material may include Al, Ag, Au, Bi, Cu, Ni, Pd, Pt, Si, Sn, Zn, Zr, or a combination thereof. The conductive polymer may be, for example, a polyphenylene derivative.

The electronic conductive material may include, for example, a carbon-metal composite including a carbon-based material and a metal-based material. In the above carbon-metal composite, the carbon-based material may be an amorphous carbon material, and the metal-based material may be a lithiophilic metal including Al, Ag, Au, Bi, Pd, Pt, Si, Sn, Zn or a combination thereof.

The electronic conductive material may be, for example, in the form of particles. At this time, the average particle diameter (D50) of the electronic conductive material may be, for example, 10 nm to 200 nm, or 50 nm to 150 nm, or 60 nm to 100 nm. Additionally, the average particle diameter (D50) of the electronic conductive material may be smaller than the average particle diameter (D50) of the solid electrolyte particles present within the region. Specifically, a ratio of the average particle diameter (D50) of the electronic conductive material to the average particle diameter (D50) of the solid electrolyte particles may be 0.1 or less, and may be 0.01 to 0.1 or 0.2 to 0.09. When the particle size of the electronic conductive material satisfies this size or size ratio, the bonding area between the negative electrode and the solid electrolyte layer can be further increased, and thus the interfacial resistance can be lowered.

The average particle diameter of the electronic conductive material can be obtained by measuring the size (diameter or length of the major axis) of about 20 particles in a scanning electron microscope image to obtain a particle size distribution and calculating D50 therefrom.

The electronic conductive material may be included in an amount of 5 wt % to 10 wt % based on 100 wt % of the total of the solid electrolyte particles and the electronic conductive material in the region. Additionally, the electronic conductive material may be included in an amount of 3 volume % to 20 volume %, for example, for example 4 volume % to 15 volume %, or 5 volume % to 10 volume % based on 100 volume % of the region. Here, the region refers to a region that is in contact with the negative electrode among the solid electrolyte layers and includes solid electrolyte particles and electronic conductive material. When the content of the electronic conductive material satisfies the above-mentioned range, the interfacial resistance between the negative electrode and the solid electrolyte layer can be effectively reduced without adversely affecting the battery.

The thickness of the region may be 10% to 60%, for example 15% to 50%, or 20% to 40% of the total thickness of the solid electrolyte layer. In this case, the interfacial resistance between the negative electrode and the solid electrolyte layer can be effectively controlled without deteriorating the performance of the all-solid-state rechargeable battery.

The solid electrolyte layer may further include a binder in addition to the solid electrolyte. The region may also further include a binder in addition to the solid electrolyte particles and the electronic conductive material.

For example, the binder may include a nitrile-butadiene rubber, hydrogenated nitrile-butadiene rubber, a styrene-butadiene rubber, an acrylated styrene-butadiene rubber, an acrylonitrile-butadiene rubber, an acrylic rubber, a butyl rubber, a fluorine rubber, polydimethylsiloxane, polyethyleneoxide, polyvinylpyrrolidone, polyvinylpyridine, chlorosulfonated polyethylene, polyvinyl alcohol, polytetrafluoroethylene, polyvinylidene fluoride, a polyvinylidene fluoride-hexafluoropropylene copolymer, polyvinylchloride, carboxylated polyvinylchloride, polyvinylfluoride, polyethylene, polypropylene, an ethylene-propylene copolymer, an ethylene-propylene-diene copolymer, polyamideimide, polyimide, poly(meth)acrylate, polyacrylonitrile, polystyrene, polyurethane, a copolymer thereof, or a combination thereof.

According to an embodiment, the solid electrolyte layer may be, for example a multilayer structure of two or more layers. The multilayer structure may include two layers, three or more layers, or two or more layers and five or fewer layers. For example, the solid electrolyte layer may include a first solid electrolyte layer in contact with the negative electrode and a second solid electrolyte layer in contact with the positive electrode. Here, the first solid electrolyte layer corresponds to the “region” described above, including first solid electrolyte particles and an electronic conductive material. The second solid electrolyte layer may include second solid electrolyte particles and may not include an electronic conductive material.

The first solid electrolyte and the second solid electrolyte may be the same or different. For example, the first solid electrolyte and the second solid electrolyte may have substantially the same composition and average particle size. As another example, the first solid electrolyte and the second solid electrolyte may have substantially the same composition but different average particle sizes.

The first solid electrolyte and the second solid electrolyte may be, for example, a sulfide-based solid electrolyte, and among them, may be an argyrodite-type sulfide-based solid electrolyte.

For example, the average particle diameter (D50) of the first solid electrolyte particles may be larger than the average particle diameter (D50) of the second solid electrolyte particles. In this case, the average particle diameter (D50) of the first solid electrolyte particles may be 2.0 μm to 5.0 μm, or 3.0 μm to 4.0 μm, and the average particle diameter (D50) of the second solid electrolyte particle may be 0.1 μm to 1.5 μm, or 0.1 μm to 1.0 μm, or 0.2 μm to 0.9 μm, or less than 1 μm.

As another example, the average particle diameter (D50) of the second solid electrolyte particles may be larger than the average particle diameter (D50) of the first solid electrolyte particles. In this case, the average particle diameter (D50) of the first solid electrolyte particles may be 0.1 μm to 1.5 μm, or 0.1 μm to 1.0 μm, or 0.2 μm to 0.9 μm, or less than 1 μm and the average particle diameter (D50) of the second solid electrolyte particle may be 2.0 μm to 5.0 μm, or 3.0 μm to 4.0 μm.

In the first solid electrolyte layer, the average particle diameter (D50) of the electronic conductive material may be smaller than the average particle diameter (D50) of the first solid electrolyte particles, and for example, a ratio of the average particle diameter (D50) of the electronic conductive material to the average particle diameter (D50) of the first solid electrolyte particles may be less than or equal to 0.1, and may be 0.01 to 0.1 or 0.2 to 0.09. In this case, the bonding area between the negative electrode and the solid electrolyte layer can be further increased, thereby lowering the interfacial resistance.

The electronic conductive material may be included in the first solid electrolyte layer in an amount of 5 wt % to 10 wt % based on 100 wt % of the total of the solid electrolyte particles and the electronic conductive material.

Additionally, the electronic conductive material may be included in an amount of 3 volume % to 20 volume %, for example 4 volume % to 15 volume %, or 5 volume % to 10 volume % based on 100 volume % of the first solid electrolyte layer. When the content of the electronic conductive material satisfies the above range, the interfacial resistance between the negative electrode and the solid electrolyte layer can be effectively reduced without adversely affecting the battery.

The thickness of the first solid electrolyte layer and the thickness of the second solid electrolyte layer may be the same or different. For example, the thickness of the first solid electrolyte layer and the thickness of the second solid electrolyte layer may be substantially the same. The thickness of the first solid electrolyte layer may be 10 μm to 200 μm, for example 10 μm to 150 μm, 10 μm to 100 μm, or 20 μm to 80 μm. The thickness of the second solid electrolyte layer may be 10 μm to 200 μm, for example 10 μm to 150 μm, 10 μm to 100 μm, or 20 μm to 80 μm.

Meanwhile, the solid electrolyte layer may further include an oxide-based inorganic solid electrolyte in addition to a sulfide-based solid electrolyte. The oxide-based inorganic solid electrolyte may include, for example, Li₁₊ₓTi₂₋ₓAl(PO₄)₃ (LTAP) (0≤x≤4), Li_{1+x+y}AlₓTi₂₋ₓSi_{y}P_{3-y}O₁₂ (0<x<2, 0≤y<3), BaTiO₃, Pb(Zr,Ti)O₃ (PZT), Pb₁₋ₓLaₓZr_{1-y}Ti_{y}O₃ (PLZT) (0≤x<1, 0≤y<1), PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂-based ceramics, Garnet-based ceramics Li₃₊ₓLa₃M₂O₁₂ (wherein M=Te, Nb, or Zr; and x is an integer of 1 to 10), or a mixture thereof.

Meanwhile, the solid electrolyte layer, or the region, or the first solid electrolyte layer and the second solid electrolyte layer may each independently further include an alkali metal salt, and/or an ionic liquid, and/or a conductive polymer.

For example, the alkali metal salt may be lithium salt. The content of lithium salt in the solid electrolyte layer may be greater than or equal to 1 M or for example 1 M to 4 M. In this case, the lithium salt can improve ionic conductivity by improving lithium ion mobility in the solid electrolyte layer.

The lithium salt may include, for example, LiSCN, LiN(CN)₂, Li(CF₃SO₂)₃C, LiC₄F₉SO₃, LiN(SO₂CF₂CF₃)₂, LiCl, LiF, LiBr, LiI, LiB(C₂O₄)₂, LiBF₄, LiBF₃(C₂F₅), lithium bis(oxalato)borate (LiBOB), lithium oxalyldifluoroborate (LIODFB), lithium difluoro(oxalato)borate (LiDFOB), lithium bis(trifluoro methanesulfonyl)imide (LiTFSI, LiN(SO₂CF₃)₂), lithium bis(fluorosulfonyl)imide (LiFSI, LiN(SO₂F)₂), LiCF₃SO₃, LiAsF₆, LiSbF₆, LiClO₄, or a mixture thereof.

In addition, the lithium salt may be an imide-based lithium salt, and for example, the imide-based lithium salt may include lithium bis(trifluoro methanesulfonyl)imide (LiTFSI, LiN(SO₂CF₃)₂), lithium bis(fluorosulfonyl)imide (LiFSI, LiN(SO₂F)₂). The lithium salt can maintain or improve ionic conductivity by maintaining appropriate chemical reactivity with ionic liquid.

The ionic liquid has a melting point below room temperature, so it is in a liquid state at room temperature and refers to a salt or room temperature molten salt composed of ions alone.

The ionic liquid may be a compound including a) at least one cation selected from ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, or triazolium-based cation, and a mixture thereof, and b) at least one anion selected from BF₄—, PF₆—, AsF₆—, SbF₆—, AlCl₄—, HSO₄—, ClO₄—, CH₃SO₃—, CF₃CO₂—, Cl—, Br—, I—, BF₄—, SO₄—, CF₃SO₃—, (FSO₂)₂N—, (C₂F₅SO₂)₂N—, (C₂F₅SO₂)(CF₃SO₂)N—, and (CF₃SO₂)₂N—.

The ionic liquid may be, for example, one or more selected from N-methyl-N-propylpyrrolidinium bis(trifluoromethanesulfonyl)imide N-butyl-N-methylpyrrolidium bis(3-trifluoromethylsulfonyl)imide, 1-butyl-3-methylimidazolium bis(trifluoromethylsulfonyl)amide, and 1-ethyl-3-methylimidazolium bis(trifluoromethylsulfonyl)amide.

A weight ratio of the solid electrolyte and the ionic liquid in the solid electrolyte layer may be 0.1:99.9 to 90:10, for example 10:90 to 90:10, 20:80 to 90:10, 30:70 to 90:10, 40:60 to 90:10, or 50:50 to 90:10. The solid electrolyte layer satisfying the above ranges may maintain or improve ionic conductivity by improving the electrochemical contact area with the electrode. Accordingly, the energy density, discharge capacity, rate capability, etc. of the all-solid-state rechargeable battery may be improved.

### Negative Electrode

A negative electrode for an all-solid-state rechargeable battery includes a current collector and a negative electrode active material layer on the current collector. The negative electrode active material layer may include a negative electrode active material, may further include a binder and/or a conductive material. In this case, the aforementioned region or first solid electrolyte layer can be a surface in contact with the negative electrode active material layer.

The negative electrode active material includes a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, for example crystalline carbon, amorphous carbon, or a combination thereof as a carbon-based negative electrode active material. The crystalline carbon may be irregular, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy may include an alloy of lithium and one or more metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOₓ (0<x<2), a Si-Q alloy (wherein Q is an alkali metal, an alkaline-earth metal, a Group 13 element, a Group 14 element, a Group 15 element, a Group 16 element, a transition metal, a rare earth element, and a combination thereof, but not Si) and the Sn-based negative electrode active material may include Sn, SnO₂, a Sn—R alloy (wherein R is an alkali metal, an alkaline-earth metal, a Group 13 element, a Group 14 element, a Group 15 element, a Group 16 element, a transition metal, a rare earth element, and a combination thereof, but not Sn). At least one of these materials may be mixed with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and a combination thereof.

For example, the negative electrode active material may include silicon-carbon composite particles. An average particle diameter (D50) of the silicon-carbon composite particles may be for example 0.5 μm to 20 μm. The average particle diameter (D50) is measured with a particle size analyzer and means a diameter of particles with a cumulative volume of 50 volume % in the particle size distribution. Silicon may be included in an amount of 10 wt % to 60 wt % and carbon may be included in an amount of 40 wt % to 90 wt % based on 100 wt % of the silicon-carbon composite particles. For example, the silicon-carbon composite particles may include a core including silicon particles, and a carbon coating layer on the surface of the core. An average particle diameter (D50) of the silicon particles may be 10 nm to 1 μm or 10 nm to 200 nm in the core. The silicon particles may exist as silicon alone, in the form of a silicon alloy, or in an oxidized form. The oxidized form of silicon may be represented by SiOₓ (0<x<2). In addition, a thickness of the carbon coating layer may be about 5 nm to 100 nm.

As an example, the silicon-carbon composite particles may include a core including silicon particles and crystalline carbon, and a carbon coating layer disposed on the surface of the core and including amorphous carbon. For example, in the silicon-carbon composite particles, amorphous carbon may not exist in the core but only in the carbon coating layer. The crystalline carbon may be artificial graphite, natural graphite, or a combination thereof, and the amorphous carbon may be may be formed from coal-based pitch, mesophase pitch, petroleum-based pitch, coal-based oil, heavy petroleum oil, or a polymer resin (phenolic resin, furan resin, polyimide, etc.). Herein, a content of the crystalline carbon may be 10 wt % to 70 wt % and a content of the amorphous carbon may be 20 wt % to 40 wt % based on 100 wt % of the silicon-carbon composite particles.

In the silicon-carbon composite particle, the core may include a void in the center. A radius of the void may be 30 length % to 50 length % of the radius of the silicon-carbon composite particle.

The aforementioned silicon-carbon composite particles effectively suppress problems such as volume expansion, structural collapse, or particle crushing due to charging and discharging, prevent disconnection of conductive paths, achieve high capacity and high efficiency, and is advantageous to use under a high-voltage or high-speed charging conditions.

The Si-based negative electrode active material or Sn-based negative electrode active material may be used by mixing with a carbon-based negative electrode active material. When using a mixture of Si-based negative electrode active material or Sn-based negative electrode active material and carbon-based negative electrode active material, a mixing ratio thereof may be 1:99 to 90:10 by weight.

A content of the negative electrode active material in the negative electrode active material layer may be 95 wt % to 99 wt % based on a total weight of the negative electrode active material layer.

In an embodiment, the negative electrode active material layer further includes the binder and optionally may further include the conductive material. A content of the binder in the negative electrode active material layer may be 1 wt % to 5 wt % based on a total weight of the negative electrode active material layer. In addition, if a conductive material is further included, the negative electrode active material layer may include 90 wt % to 98 wt % of the negative electrode active material, 1 wt % to 5 wt % of the binder, and 1 wt % to 5 wt % of the conductive material.

The binder serves to well adhere the negative electrode active material particles to each other and also to adhere the negative electrode active material to the current collector. The binder may be a water-insoluble binder, a water-soluble binder, or a combination thereof.

The water-insoluble binder may be polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

The water-soluble binder may include a rubber binder or a polymer resin binder. The rubber binder may be selected from a styrene-butadiene rubber, an acrylated styrene-butadiene rubber, an acrylonitrile-butadiene rubber, an acrylic rubber, a butyl rubber, a fluororubber, and a combination thereof. The polymer resin binder may be selected from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

When a water-soluble binder is used as the negative electrode binder, a cellulose-based compound capable of imparting viscosity as a type of thickener may be further included. As this cellulose-based compound, one or more types of carboxymethyl cellulose, hydroxypropylmethyl cellulose, methyl cellulose, or an alkali metal salt thereof may be used. The alkali metal may be Na, K, or Li. The amount of the thickener used may be 0.1 parts by weight to 3 parts by weight based on 100 parts by weight of the negative electrode active material.

The conductive material is used to impart conductivity to the electrode, and any material that does not cause chemical change and conducts electrons can be used in the battery. Examples of the conductive material may include a carbon-based material such as natural graphite, artificial graphite, carbon black, acetylene black, ketjen black, a carbon fiber, a carbon nanofiber, a carbon nanotube, and the like; a metal-based material of a metal powder or a metal fiber including copper, nickel, aluminum, silver, and the like; a conductive polymer such as a polyphenylene derivative; or a mixture thereof.

The negative electrode current collector may include one selected from a copper foil, a nickel foil, a stainless steel foil, a titanium foil, a nickel foam, a copper foam, a polymer substrate coated with a conductive metal, and a combination thereof.

### Precipitation-Type Negative Electrode

As another example, the negative electrode for an all-solid-state rechargeable battery may be a precipitation-type negative electrode. The precipitation-type negative electrode does not include a negative electrode active material during battery assembly, but may refer to a negative electrode in which lithium metal, etc. is precipitated or electrodeposited on the negative electrode during battery charging, thereby serving as a negative electrode active material.

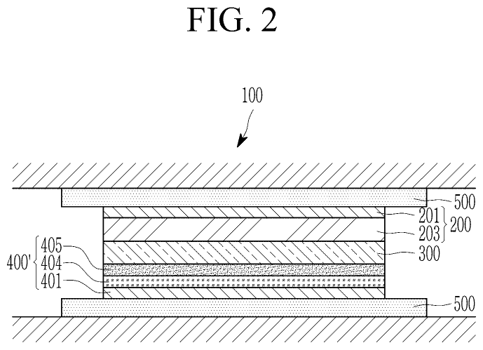

FIG. 2 is a schematic cross-sectional view of an all-solid-state rechargeable battery including a precipitation-type negative electrode. Referring to FIG. 2, the precipitation-type negative electrode 400′ may include a current collector 401 and a negative electrode coating layer 405 on the current collector. In an all-solid-state rechargeable battery having such a precipitation-type negative electrode 400′, initial charging begins in the absence of negative electrode active material, and during charging, high-density lithium metal is precipitated or electrodeposited between the current collector 401 and the negative electrode coating layer 405 or on the negative electrode coating layer 405 to form a lithium metal layer 404, which can serve as a negative electrode active material. Accordingly, in an all-solid-state rechargeable battery that has been charged at least once, the precipitation-type negative electrode 400′ may include, for example, a current collector 401, a lithium metal layer 404 on the current collector, and a negative electrode coating layer 405 on the metal layer. The lithium metal layer 404 may be referred to as a layer in which lithium metal, etc. is precipitated during the charging process of the battery, and may be referred to as a metal layer, lithium layer, lithium electrodeposition layer, or negative electrode active material layer.

In this case, the aforementioned region or first solid electrolyte layer can be a surface in contact with the negative electrode coating layer 405.

The negative electrode coating layer 405 may also be referred to as a lithium electrodeposition inducing layer or a negative electrode catalyst layer, and may include a metal, a carbon material, or a combination thereof that acts as a catalyst.

The metal may be a lithiophilic metal and may include, for example, gold, platinum, palladium, silicon, silver, aluminum, bismuth, tin, zinc, or a combination thereof, and may be composed of one of these or various types of alloys. If the metal is present in particle form, an average particle diameter (D50) thereof may be less than or equal to about 4 μm, for example, 10 nm to 4 μm.

The carbon material may be, for example, crystalline carbon, amorphous carbon, or a combination thereof. The crystalline carbon may be for example natural graphite, artificial graphite, mesophase carbon microbeads, or a combination thereof. The amorphous carbon may be for example carbon black, activated carbon, acetylene black, denka black, ketjen black, or a combination thereof.

If the negative electrode coating layer 405 includes the metal and the carbon material, the metal and the carbon material may be, for example, mixed in a weight ratio of 1:10 to 2:1. Herein, the precipitation of the lithium metal may be effectively promoted and improve characteristics of the all-solid-state battery. The negative electrode coating layer 405 may include, for example, a carbon material on which a catalyst metal is supported or a mixture of metal particles and carbon material particles.

The negative electrode coating layer 405 may include, for example the lithiophilic metal and amorphous carbon, and in this case, the deposition of lithium metal may be effectively promoted. As a specific example, the negative electrode coating layer 405 may include a composite in which a lithiophilic metal is supported on amorphous carbon.

The negative electrode coating layer 405 may further include a binder, and the binder may be, for example, a conductive binder. Additionally, the negative electrode coating layer 405 may further include general additives such as a filler, a dispersant, an ion conductive agent, and the like.

A thickness of the negative electrode coating layer 405 may be for example 100 nm to 20 μm, 500 nm to 10 μm, or 1 μm m to 5 μm.

The precipitation-type negative electrode 400′ may further include a thin film, for example, on the surface of the current collector, that is, between the current collector and the negative electrode catalyst layer. The thin film may include an element capable of forming an alloy with lithium. The element capable of forming an alloy with lithium may be, for example, gold, silver, zinc, tin, indium, silicon, aluminum, bismuth, and the like, which may be used alone or an alloy of more than one. The thin film may further planarize a precipitation shape of the lithium metal layer 404 and much improve characteristics of the all-solid-state rechargeable battery. The thin film may be formed, for example in a vacuum deposition method, a sputtering method, a plating method, and the like. The thin film may have, for example, a thickness of 1 nm to 500 nm.

The lithium metal layer 404 may include lithium metal or lithium alloy. For example, the lithium alloy may be Li—Al alloy, Li—Sn alloy, Li—In alloy, Li—Ag alloy, Li—Au alloy, Li—Zn alloy, Li—Ge alloy, or Li—Si alloy.

A thickness of the lithium metal layer 404 may be 1 μm to 500 μm, 1 μm to 200 μm, 1 μm to 100 μm, or 1 μm to 50 μm. If the thickness of the lithium metal layer 404 is too thin, it is difficult to perform the role of a lithium storage, and if it is too thick, the battery volume may increase and performance may deteriorate.

When applying such a precipitation-type negative electrode, the negative electrode coating layer 405 may serve to protect the lithium metal layer 404 and suppress the precipitation growth of lithium dendrite. Accordingly, short circuit and capacity degradation of the all-solid-state battery may be suppressed and cycle-life characteristics can be improved.

### Positive Electrode

In an embodiment, the positive electrode includes a current collector and a positive electrode active material layer on the current collector, wherein the positive electrode active material layer includes a positive electrode active material and a solid electrolyte, and optionally a binder and/or a conductive material.

### Positive Electrode Active Material

The positive electrode active material may be applied without limitation as long as it is generally used in all-solid-state rechargeable batteries. For example, the positive electrode active material may be a compound being capable of intercalating and deintercalating lithium, and may include a compound represented by one of the following chemical formulas.

$${Li}_{a} {A}_{1 - b} {X}_{b} {D}_{2} ( 0.9 \leq a \leq 1.8 , 0 \leq b \leq 0.5 ) ;$$

$${Li}_{a} {A}_{1 - b} {X}_{b} {O}_{2 - c} {D}_{c} ( 0.9 \leq a \leq 1.8 , 0 \leq b \leq 0.5 , 0 \leq c \leq 0.05 ) ;$$

$${Li}_{a} {E}_{1 - b} {X}_{b} {O}_{2 - c} {D}_{c} ( 0.9 \leq a \leq 1.8 , 0 \leq b \leq 0.5 , 0 \leq c \leq 0.05 ) ;$$

$${Li}_{a} {E}_{2 - b} {X}_{b} {O}_{4 - c} {D}_{c} ( 0.9 \leq a \leq 1.8 , 0 \leq b \leq 0.5 , 0 \leq c \leq 0.05 ) ;$$

$${Li}_{a} {Ni}_{1 - b - c} {Co}_{b} {X}_{c} {D}_{α} ( 0.9 \leq a \leq 1.8 , 0 \leq b \leq 0.5 , 0 \leq c \leq 0.5 , 0 < α \leq 2 ) ;$$

$${Li}_{a} {Ni}_{1 - b - c} {Co}_{b} {X}_{c} {O}_{2 - α} {T}_{α} ( 0.9 \leq a \leq 1.8 , 0 \leq b \leq 0.5 , 0 \leq c \leq 0.05 , 0 < α < 2 ) ;$$

$${Li}_{a} {Ni}_{1 - b - c} {Co}_{b} {X}_{c} {O}_{2 - α} {T}_{2} ( 0.9 \leq a \leq 1.8 , 0 \leq b \leq 0.5 , 0 \leq c \leq 0.05 , 0 < α < 2 ) ;$$

$${Li}_{a} {Ni}_{1 - b - c} {Mn}_{b} {X}_{c} {D}_{α} ( 0.9 \leq a \leq 1.8 , 0 \leq b \leq 0.5 , 0 \leq c \leq 0.05 , 0 < α \leq 2 ) ;$$

$${Li}_{a} {Ni}_{1 - b - c} {Mn}_{b} {X}_{c} {O}_{2 - α} {T}_{α} ( 0.9 \leq a \leq 1.8 , 0 \leq b \leq 0.5 , 0 \leq c \leq 0.05 , 0 < α < 2 ) ;$$

$${Li}_{a} {Ni}_{1 - b - c} {Mn}_{b} {X}_{c} {O}_{2 - α} {T}_{2} ( 0.9 \leq a \leq 1.8 , 0 \leq b \leq 0.5 , 0 \leq c \leq 0.05 , 0 < α < 2 ) ;$$

$${Li}_{a} {Ni}_{b} {E}_{c} {G}_{d} {O}_{2} ( 0.9 \leq a \leq 1.8 , 0 \leq b \leq 0.9 , 0 \leq c \leq 0.5 , 0.001 \leq d \leq 0.1 ) ;$$

$${Li}_{a} {Ni}_{b} {Co}_{c} {Mn}_{d} {G}_{e} {O}_{2} ( 0.9 \leq a \leq 1.8 , 0 \leq b \leq 0 \text{.9} , 0 \leq c \leq 0.5 , 0 \leq d \leq 0.5 , 0.001 \leq e \leq 0 \text{.1} ) ;$$

$${Li}_{a} {Ni G}_{b} {O}_{2} ( 0.9 \leq a \leq 1.8 , 0.001 \leq b \leq 0 \text{.1} ) ;$$

$${Li}_{a} {Co G}_{b} {O}_{2} ( 0.9 \leq a \leq 1.8 , 0.001 \leq b \leq 0 \text{.1} ) ;$$

$${Li}_{a} {Mn}_{1 - b} {G}_{b} {O}_{2} ( 0.9 \leq a \leq 1.8 , 0.001 \leq b \leq 0 \text{.1} ) ;$$

$${Li}_{a} {Mn}_{2} {G}_{b} {O}_{4} ( 0.9 \leq a \leq 1.8 , 0.001 \leq b \leq 0 \text{.1} ) ;$$

$${Li}_{a} {Mn}_{1 - g} {G}_{g} {PO}_{4} ( 0.9 \leq a \leq 1.8 , 0 \leq g \leq 0 \text{.5} ) ;$$

$$Q {O}_{2} , {Q S}_{2} , {Li Q S}_{2} ;$$

$${V}_{2} {O}_{5} , {LiV}_{2} {O}_{5} ;$$

$${Li Z O}_{2} ;$$

$${LiNiVO}_{4} ;$$

$${Li}_{( 3 - f )} {{J}_{2} ( {PO}_{4} )}_{3} ( 0 \leq f \leq 2 ) ;$$

$${Li}_{( 3 - f )} {{Fe}_{2} ( {PO}_{4} )}_{3} ( 0 \leq f \leq 2 ) ;$$

$${Li}_{a} {FePO}_{4} ( 0.9 \leq a \leq 1.8 ) .$$

In the chemical formulas, A is selected from Ni, Co, Mn, and a combination thereof; X is selected from Al, Ni, Co, Mn, Cr, Fe, Mg, Sr, V, rare earth elements, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The positive electrode active material may be, for example, a lithium cobalt oxide (LCO), a lithium nickel oxide (LNO), a lithium nickel cobalt oxide (NC), a lithium nickel cobalt aluminum oxide (NCA), a lithium nickel cobalt manganese oxide (NCM), a lithium nickel manganese oxide (NM), a lithium manganese oxide (LMO), or lithium iron phosphate (LFP).

For example, the positive electrode active material may include lithium nickel-based oxide represented by Chemical Formula 11, lithium cobalt-based oxide represented by Chemical Formula 12, a lithium iron phosphate-based compound represented by Chemical Formula 13, and cobalt-free lithium nickel-manganese-based oxide represented by Chemical Formula 14, or a combination thereof.

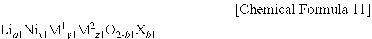

In Chemical Formula 11, 0.9≤a1≤1.8, 0.3≤x1≤1, 0≤y1≤0.7, 0≤z1≤0.7, 0.9≤x1+y1+z1≤1.1, 0≤b1≤0.1, M¹ and M² are one or more elements independently selected from Al, B, Ba, Ca, Ce, Co, Cr, Cu, Fe, Mg, Mn, Mo, Nb, Si, Sn, Sr, Ti, V, W, and Zr, and X is one or more elements selected from F, P, and S.

In Chemical Formula 11, 0.6≤x1≤1, 0≤y1≤0.4, and 0≤z1≤0.4 or 0.8≤x1≤1, 0≤y1≤0.2, and 0≤z1≤0.2.

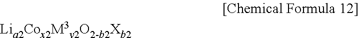

In Chemical Formula 12, 0.9≤a2≤1.8, 0.7≤x2≤1, 0≤y2≤0.3, 0.9≤x2+y2≤1.1, and 0≤b2≤0.1, M³ is one or more elements selected from Al, B, Ba, Ca, Ce, Cr, Cu, Fe, Mg, Mn, Mo, Ni, Se, Si, Sn, Sr, Ti, V, W, Y, Zn, and Zr, and X is one or more elements selected from F, P, and S.

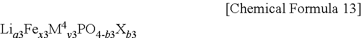

In Chemical Formula 13, 0.9≤a3≤1.8, 0.6≤x3≤1, 0≤y3≤0.4, and 0≤b3≤0.1, M⁴ is one or more elements selected from Al, B, Ba, Ca, Ce, Co, Cr, Cu, Mg, Mn, Mo, Ni, Se, Si, Sn, Sr, Ti, V, W, Y, Zn and Zr, and X is one or more elements selected from F, P, and S.

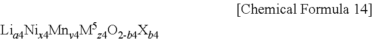

In Chemical Formula 14, 0.9≤a2≤1.8, 0.8≤x4<1, 0<y4≤0.2, 0≤z4≤0.2, 0.9≤x4+y4+z4≤1.1, and 0≤b4≤0.1, M⁵ is one or more elements selected from Al, B, Ba, Ca, Ce, Cr, Fe, Mg, Mo, Nb, Si, Sn, Sr, Ti, V, W, and Zr, and X is one or more elements selected from F, P, and S.

An average particle diameter (D50) of the positive electrode active material may be 1 μm to 25 μm, for example 3 μm to 25 μm, 1 μm to 20 μm, 1 μm to 18 μm, 3 μm to 15 μm, or 5 μm to 15 μm. For example, the positive electrode active material may include small particles having an average particle diameter (D50) of 1 μm to 9 μm and large particles having an average particle diameter (D50) of 10 μm to 25 μm. The positive electrode active material having this particle size range can be harmoniously mixed with other components within the positive electrode active material layer and can achieve high capacity and high energy density. Herein, the average particle diameter means a diameter (D50) of particles having a cumulative volume of 50 volume % in the particle size distribution that is obtained by measuring the size (diameter or length of the major axis) of about 20 particles at random in a scanning electron microscope image for positive electrode active materials.

The positive electrode active material may be in the form of secondary particles made by agglomerating a plurality of primary particles or in the form of single particles. Additionally, the positive electrode active material may have a spherical or close to spherical shape, or may have a polyhedral or irregular shape.

Meanwhile, the positive electrode active material may include a buffer layer on the surface of the particles. The buffer layer may be expressed as a coating layer, a protective layer, etc., and may serve to lower the interfacial resistance between the positive electrode active material and the sulfide-based solid electrolyte particles. For example, the buffer layer may include lithium-metal-oxide, wherein the metal may be for example one or more elements selected from Al, B, Ca, Ce, Cr, Fe, Mg, Mo, Nb, Si, Sn, Sr, Ta, V, W, and Zr. The lithium-metal-oxide improves the performance of the positive electrode active material by facilitating the movement of lithium ions and electronic conduction, and is improved for lowering the interfacial resistance between the positive electrode active material and solid electrolyte particles.

The positive electrode active material may be included in an amount of 55 wt % to 99 wt %, for example 65 wt % to 95 wt %, or 75 wt % to 91 wt % based on 100 wt % of the positive electrode active material layer.

### Solid Electrolyte

The solid electrolyte included in the positive electrode active material layer may include a sulfide-based solid electrolyte, an oxide-based solid electrolyte, or a combination thereof, and may be, for example, an argyrodite-type sulfide-based solid electrolyte. Because the solid electrolyte has been described above, detailed descriptions therefor is omitted.

The solid electrolyte may be included in an amount of 0.1 wt % to 35 wt %, for example 1 wt % to 35 wt %, 5 wt % to 30 wt %, 8 wt % to 25 wt %, or 10 wt % to 20 wt % based on 100 wt % of the positive electrode active material layer.

Additionally, the positive electrode active material may be included in an amount of 5 wt % to 99 wt % and the solid electrolyte may be included in an amount of 1 wt % to 35 wt %, for example the positive electrode active material may be included in an amount of 80 wt % to 90 wt %, and the solid electrolyte may be included in an amount of 10 wt % to 20 wt % based on a total weight of the positive electrode active material and solid electrolyte in the positive electrode active material layer. If the solid electrolyte is included in the positive electrode at such an amount, the efficiency and cycle-life characteristics of the all-solid-state battery can be improved without reducing the capacity.

### Binder

The binder serves to adhere the positive electrode active material particles to each other and also to properly attach the positive electrode active material to the current collector. Examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

A content of the binder may be approximately 0.1 wt % to 5 wt % based on 100 wt % of the positive electrode active material layer in the positive electrode active material layer.

### Conductive Material

The positive electrode active material layer may further include a conductive material. The conductive material is used to impart conductivity to the electrode, and any material that does not cause chemical change and conducts electrons can be used in the battery. Examples thereof may include a carbon-based material such as natural graphite, artificial graphite, carbon black, acetylene black, ketjen black, a carbon fiber, a carbon nanofiber, a carbon nanotube, and the like; a metal-based material including copper, nickel, aluminum, silver, etc. in a form of a metal powder or a metal fiber; a conductive polymer such as a polyphenylene derivative; or a mixture thereof.

A content of the conductive material in the positive electrode active material layer may be 0 wt % to 3 wt %, 0.01 wt % to 2 wt %, or 0.1 wt % to 1 wt % based on 100 wt % of the positive electrode active material layer.

The positive electrode current collector may include an aluminum foil, but is not limited thereto.

An all-solid-state rechargeable battery may be a unit cell with a structure of positive electrode/solid electrolyte layer/negative electrode, a bicell with a structure of positive electrode/solid electrolyte layer/negative electrode/solid electrolyte layer/positive electrode, or a stacked battery in which the structure of the unit cell is repeated.

The shape of the all-solid-state rechargeable battery is not particularly limited, and may be, for example, coin-shaped, button-shaped, sheet-shaped, stacked-shaped, cylindrical, flat, etc. In addition, the all-solid-state rechargeable battery may be applied to a large-sized battery used in an electric vehicle or the like. For example, the all-solid-state rechargeable battery may also be used in hybrid vehicles such as plug-in hybrid electric vehicles (PHEV). In addition, it may be used in a field requiring a large amount of power storage, and may be used, for example, in an electric bicycle or a power tool. In addition, the all-solid-state rechargeable battery may be used in various fields such as portable electronic devices.

### MODE FOR INVENTION

Hereinafter, examples and comparative examples of the present invention will be described. The following examples are only examples of the present invention and the present invention is not limited to the following examples.

### Example 1

### 1. Manufacturing of Negative Electrode

A negative electrode coating layer composition was prepared by mixing carbon black with a primary particle diameter (D50) of about 30 nm and silver (Ag) with an average particle diameter (D50) of about 60 nm in a weight ratio of 3:1 to prepare an Ag/C composite, adding 0.25 g of the Ag/C composite to 2 g of an NMP solution including 7 wt % of a polyvinylidene fluoride binder, and then, mixing them. The negative electrode coating layer composition was coated on a nickel foil current collector with a bar coater and then, vacuum-dried and compressed to manufacture a negative electrode including a negative electrode coating layer on the current collector.

### 2. Formation of First Solid Electrolyte Layer

A first composition was prepared by dissolving an acryl-based binder (SX-A334, Zeon Corp.) in an isobutyryl isobutyrate (IBIB) solvent to obtain a binder solution and adding 95 wt % of an argyrodite type solid electrolyte of Li₆PS₅Cl (D50=0.7 μm) and 5 wt % of an amorphous carbon material with an average particle diameter of about 100 nm as an electronic conductive material thereto. The first composition was coated on the negative electrode coating layer of the negative electrode by using a blade coater to form a first solid electrolyte layer.

### 3. Formation of Second Solid Electrolyte Layer

A second composition was prepared by dissolving an acryl-based binder (SX-A334, Zeon Corp.) in an IBIB solvent to obtain a binder solution, adding an argyrodite-type solid electrolyte of Li₆PS₅Cl (D50=3.5 μm) thereto, and stirring the mixture. The second composition was coated with the blade coater on the first solid electrolyte layer to form a second solid electrolyte layer and then, dried at 80° C. for 10 minutes.

### 4. Manufacturing of Positive Electrode

85 wt % of a positive electrode active material of LiNi_{0.9}Co_{0.05}Mn_{0.05}O₂ coated with Li₂O—ZrO₂, 13.5 wt % of an argyrodite-type solid electrolyte of Li₆PS₅Cl, 1.0 wt % of a PVdF binder, and 0.5 wt % of a carbon nanotube conductive material were mixed in an IBIB solvent to prepare a positive electrode composition. The prepared positive electrode composition was coated on a positive electrode current collector with the bar coater and then, dried in a convection oven at 80° C. for 10 minutes to manufacture a positive electrode having a positive electrode active material layer on the current collector.

5. Manufacturing of all-Solid-State Rechargeable Battery Cell

The manufactured positive electrode was stacked on the second solid electrolyte layer, so that the positive electrode active material layer of the positive electrode was in contact with the second solid electrolyte layer. The negative electrode, the first solid electrolyte layer, the second solid electrolyte layer, and the positive electrode were sequentially stacked to obtain an assembly, which was injected into a pouch, and then, the pouch was sealed and subjected to warm isostatic press (WIP) at a high temperature of 85° C. under 500 Mpa for 30 minutes to manufacture an all-solid-state rechargeable battery cell.

In the all-solid-state rechargeable battery cell, the first solid electrolyte layer and the second solid electrolyte layer respectively had a thickness of about 50 μm.

### Example 2

An all-solid-state rechargeable battery was manufactured substantially in the same manner as in Example 1 except that 5 wt % of nano silver particles with an average particle diameter of about 150 nm was used instead of the electronic conductive material added to the first solid electrolyte layer in Example 1.

### Comparative Example 1

An all-solid-state rechargeable battery was manufactured substantially in the same manner as in Example 1 except that the second solid electrolyte layer alone was formed to have twice the thickness without forming the first solid electrolyte layer in Example 1.

### Comparative Example 2

An all-solid-state rechargeable battery was manufactured substantially in the same manner as in Example 1 except that the first solid electrolyte layer alone was formed to have twice the thickness without forming the second solid electrolyte layer in Example 1.

### Evaluation Example 1: Battery Performance Evaluation

The all-solid-state rechargeable battery cells of Examples 1 and 2 and Comparative Examples 1 and 2 were charged to an upper limit voltage of 4.25 V at a constant current of 0.1 C and discharged to a cut-off voltage of 2.5 V at 0.1 C at 45° for initial charge and discharge. Table 1 shows initial charge amount, initial discharge amount, and the efficiency in terms of the ratio of discharge amount to charge amount.

TABLE 1

| | Charge amount | Discharge amount | Efficiency |
|---|---|---|---|
| | (mAh/g) | (mAh/g) | (%) |
| Example 1 | 242.1 | 209.5 | 86.5 |
| Example 2 | 250.8 | 216.6 | 86.4 |
| Comparative Example 1 | 242.0 | 207.7 | 85.8 |
| Comparative Example 2 | 244.2 | 190.8 | 78.1 |

Referring to Table 1 and FIG. 3, Examples 1 and 2 have higher initial discharge amounts and initial charge/discharge efficiencies than Comparative Examples 1 and 2. While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

### DESCRIPTION OF SYMBOLS

100: all-solid-state battery
200: positive electrode
201: positive electrode current collector
203: positive electrode active material layer
300: solid electrolyte layer
400: negative electrode
401: negative electrode current collector
403: negative electrode active material layer
400′: precipitation-type negative electrode
404: lithium metal layer
405: negative electrode coating layer
500: elastic layer

1. An all-solid-state rechargeable battery, comprising
a negative electrode, a positive electrode, and a solid electrolyte layer between the negative electrode and the positive electrode,
wherein the solid electrolyte layer includes a region including solid electrolyte particles and an electronic conductive material on a side in contact with the negative electrode.

2. The all-solid-state rechargeable battery as claimed in claim 1, wherein the solid electrolyte particles are sulfide-based solid electrolyte particles.

3. The all-solid-state rechargeable battery as claimed in claim 2, wherein the sulfide-based solid electrolyte particles comprise argyrodite-type sulfide.

4. The all-solid-state rechargeable battery as claimed in claim 1, wherein
an average particle diameter (D50) of the sulfide-based solid electrolyte particles is 0.1 μm to 5.0 μm.

5. The all-solid-state rechargeable battery as claimed in claim 1, wherein the electronic conductive material comprises a carbon-based material, a metal-based material, a conductive polymer, or a combination thereof.

6. The all-solid-state rechargeable battery as claimed in claim 5, wherein
the carbon-based material comprises natural graphite, artificial graphite, carbon black, acetylene black, denka black, ketjen black, carbon fiber, carbon nanofiber, carbon nanotube, or a combination thereof, and
the metal-based material comprises Al, Ag, Au, Bi, Cu, Ni, Pd, Pt, Si, Sn, Zn, Zr, or a combination thereof.

7. The all-solid-state rechargeable battery as claimed in claim 1, wherein
the electronic conductive material comprises a carbon-metal composite of a carbon-based material and a metal-based material.

8. The all-solid-state rechargeable battery as claimed in claim 7, wherein
in the carbon-metal composite, the carbon-based material is an amorphous carbon material and the metal-based material is a lithiophilic metal including Al, Ag, Au, Bi, Pd, Pt, Si, Sn, Zn, or a combination thereof.

9. The all-solid-state rechargeable battery as claimed in claim 1, wherein
the electronic conductive material is in a form of particles and an average particle diameter (D50) of the particles is 10 nm to 200 nm.

10. The all-solid-state rechargeable battery as claimed in claim 1, wherein
the electronic conductive material is in a form of particles and an average particle diameter (D50) of the particles is smaller than the average particle diameter (D50) of the solid electrolyte particles.

11. The all-solid-state rechargeable battery as claimed in claim 10, wherein
a ratio of the average particle diameter (D50) of the electronic conductive material to the average particle diameter (D50) of the solid electrolyte particles is less than or equal to 0.1.

12. The all-solid-state rechargeable battery as claimed in claim 1, wherein
the electronic conductive material is included in an amount of 5 to 10 wt % based on 100 wt % of the total of the solid electrolyte particles and the electronic conductive material in the region.

13. The all-solid-state rechargeable battery as claimed in claim 1, wherein
the electronic conductive material is included in an amount of 3 to 20 volume % based on 100 volume % of the region.

14. The all-solid-state rechargeable battery as claimed in claim 1, wherein a thickness of the region is 10% to 60% of the total thickness of the solid electrolyte layer.

15. The all-solid-state rechargeable battery as claimed in claim 1, wherein
the solid electrolyte layer includes a first solid electrolyte layer in contact with the negative electrode and a second solid electrolyte layer in contact with the positive electrode,
the first solid electrolyte layer comprises first solid electrolyte particles and an electronic conductive material, and
the second solid electrolyte layer comprises second solid electrolyte particles.

16. The all-solid-state rechargeable battery as claimed in claim 15, wherein
the average particle diameter (D50) of the first solid electrolyte particles is larger than the average particle diameter (D50) of the second solid electrolyte particles.

17. The all-solid-state rechargeable battery as claimed in claim 15, wherein
the average particle diameter (D50) of the second solid electrolyte particles is larger than the average particle diameter (D50) of the first solid electrolyte particles.

18. The all-solid-state rechargeable battery as claimed in claim 15, wherein
a thickness of the first solid electrolyte layer is 10 μm to 200 μm, and
a thickness of the second solid electrolyte layer is 10 μm to 200 μm.

19. The all-solid-state rechargeable battery as claimed in claim 1, wherein
the negative electrode comprises a current collector and a negative electrode coating layer located on the current collector and including a lithiophilic metal, a carbon material, or a combination thereof, and
a lithium metal layer formed by charging between the above-described collector and the negative electrode coating layer is included.

20. The all-solid-state rechargeable battery as claimed in claim 1, wherein
the positive electrode comprises a current collector and a positive electrode active material layer located on the current collector and including a positive electrode active material, and
the positive electrode active material comprises lithium cobalt oxide, lithium nickel oxide, lithium nickel cobalt oxide, lithium nickel cobalt aluminum oxide, lithium nickel cobalt manganese oxide, lithium nickel manganese oxide, lithium manganese oxide, lithium iron phosphate, or a combination thereof.
